(19) United States
(12) Patent Application Publication
(10) Pub. No.: US 2021/0031272 A1
(43) Pub. Date: Feb. 4, 2021

(54) EXTERNAL COOLING TEXTURE TURNING TOOL COMPONENT AND TURNING PROCESS SYSTEM FOR COUPLING NANOFLUID MINIMUM QUANTITY LUBRICANT WITH MICRO-TEXTURE TOOL

(71) Applicants: QINGDAO UNIVERSITY OF TECHNOLOGY, Qingdao (CN); NINGBO SANHAN ALLOY MATERIAL CO., LTD., Ningbo (CN)

(72) Inventors: Changhe LI, Qingdao (CN); Xiaoming WANG, Qingdao (CN); Liang LUO, Ningbo (CN); Huajun CAO, Qingdao (CN); Bingheng LU, Qingdao (CN); Runze LI, Qingdao (CN); Yanbin ZHANG, Qingdao (CN); Huiming LUO, Qingdao (CN); Yuchen DIAO, Qingdao (CN); Haizhou XU, Qingdao (CN); Dongzhou JIA, Qingdao (CN); Min YANG, Qingdao (CN); Yali HOU, Qingdao (CN)

(73) Assignees: QINGDAO UNIVERSITY OF TECHNOLOGY; NINGBO SANHAN ALLOY MATERIAL CO., LTD.

(21) Appl. No.: 16/725,938

(22) Filed: Dec. 23, 2019

(30) Foreign Application Priority Data
May 31, 2019 (CN) 201910471330.1

(51) Int. Cl. B23B 27/10; B23B 27/16; B23Q 11/10; B23B 1/00

(52) U.S. Cl. CPC B23B 27/10; B23B 1/00; B23Q 11/10; B23B 27/1614

(57) ABSTRACT

Provided is an external cooling texture turning tool component and a turning process system for coupling nanofluid minimum quantity lubricant with a micro-texture tool. The external cooling texture turning tool component comprises an external cooling turning tool handle and an external cooling turning tool blade; the external cooling turning tool blade is arranged at one end of the external cooling turning tool handle serving as a bearing device; an external cooling turning tool pad is arranged between the external cooling turning tool blade and a structure of the external cooling turning tool handle bearing the blade; an external cooling turning tool pressing plate part is further arranged on the external cooling turning tool handle; the external cooling turning tool blade is tightly pressed on the external cooling turning tool handle by the external cooling turning tool pressing plate part.

### CROSS-REFERENCE TO RELATED APPLICATIONS

This application claims priority to Chinese Patent Application No. 201910471330.1 with a filing date of May 31, 2018. The content of the aforementioned applications, including any intervening amendments thereto, are incorporated herein by reference.

### TECHNICAL FIELD

The present disclosure relates to the technical field of machining, and particularly relates to an external cooling texture turning tool component with an external nozzle, a turning process system for coupling nanofluid minimum quantity lubricant (NMQL) with a micro-texture tool and an intelligent supply method.

### BACKGROUND OF THE PRESENT INVENTION

During metal cutting, cutting fluid and additives have been widely used because they can play the roles of cooling, lubrication, cleaning, chip removal and rust prevention, but they also bring many negative effects, such as environmental pollution, harm to human health and increase in manufacturing cost, and may increase tool wear and reduce surface quality of workpieces due to improper use. With requirements of national sustainable development strategies, the manufacturing industry in China pursues a high-quality, high-efficiency and low-cost production mode. Meanwhile, environmental protection regulations have become increasingly stringent. Cooling methods of pouring a large amount of cutting fluid are no longer in line with the development direction of production. Measures must be taken to change this resource-consuming manufacturing mode to realize green and sustainable production. In recent years, all countries in the world and organizations such as the International Academy for Production Engineering (CIRP), the American Society of Mechanical Engineers (ASME) and the Institute of Electrical and Electronic Engineers (IEEE) have conducted a lot of research on cutting technologies for eliminating or reducing hazards of the cutting fluid, and have made great efforts to apply the cutting technologies to production practice. Dry cutting, compound machining, green cooling and other technologies can be adopted to eliminate or reduce the hazards of cooling fluid, wherein dry cutting can fundamentally solve many negative effects brought by the cutting fluid, but in many cases, the service life of the tool is short and the surface roughness of the workpieces is extremely poor due to high cutting temperature, so it is not feasible to use full dry cutting. Therefore, super-hard tool materials and coated tools are generally used in dry cutting, and a high-speed cutting technology is adopted, but the theory of the high-speed cutting technology is not perfect. Compound machining technologies such as heating and ultrasonic vibration-combined assisted cutting are expensive in complete set of equipment and are in a research stage. However, pollution-free or less-pollution cooling technologies have been widely used in industry. At present, green cooling technologies such as cold air cooling, minimum quantity lubricant (MQL) cooling, water vapor, heat pipe cooling and internal cooling have emerged, and also have good cooling effects. Therefore, the technology of realizing near-dry cutting through an MQL device has feasibility and extremely high application prospect.

Traditional tribology holds that the smoother the two surfaces in contact with each other are, the smaller the amount of wear is. However, the recent research has shown that the surface with better smoothness does not have better wear resistance, but the surface with a certain non-smooth shape has better wear resistance. The research on the surface with a non-smooth shape is a research on the surface with a texture. The so-called surface texture means that geometric microstructures with certain characteristics are designed by utilizing geometric graphics theories or bionics theories, and microstructure arrays are machined on the surfaces by means of laser machining and the like to change geometries of the surfaces, thereby improving contact performance between the surfaces, reducing friction and improving lubrication conditions. Therefore, appropriate geometric microfeatures are the premise of texture modification and have great engineering value for improving friction performance between contact pairs. The surface texture can improve the friction performance of friction pairs mainly because micro-dimples or indentations of the surface texture can play the role of an oil reservoir and can form lubricating films on the surfaces of the friction pairs in time, thereby reducing friction and wear on the surfaces of the friction pairs. The lubrication effect of the lubricant oil on the surfaces of the friction pairs is mainly realized in such a manner that the lubricating oil is driven to form the lubricating films on the surfaces by relative motion generated between the two friction pairs, so as to reduce direct contact between the surfaces of the two friction pairs, thereby reducing the friction and wear. When dimples or indentations exist, the lubricant oil will be stored in the dimples or indentations. When the surfaces of the two friction pairs start to move relative to each other, a relative movement speed is generated. The lubricating oil adheres to the surfaces of the friction pairs due to viscosity and rapidly forms the lubricating films on the surfaces under the driving of the surfaces, thereby shortening the forming time of the lubricating films and playing the roles of resisting friction and reducing wear.

The MQL cutting technology refers to a cutting method in which a minimum quantity of lubrication liquid and a gas having a certain pressure are mixed and atomized, and then conveyed to friction interfaces to play the roles of cooling and lubrication. The high-pressure gas mainly plays the roles of cooling and chip removal. The MQL achieves or even exceeds the lubrication effect of pouring type, and has great advantages and development prospects in replacing traditional pouring type cooling lubrication. However, the research shows that the high-pressure gas with atomizing effect does not achieve the expected good cooling effect.

The NMQL inherits all the advantages of the MQL, solves a heat exchange problem of MQL cutting, and is an energy-saving, environmentally friendly, green and low-carbon cutting technology. Due to a heat transfer enhancement mechanism that heat transfer performance of solid is greater than that of liquid while the heat transfer performance of the liquid is greater than that of gas, an appropriate amount of nano-scale solid particles are added to biodegradable MQL liquid to form a nanofluid; and the NMQL liquid is atomized by a compressed gas and is conveyed to tool/chip interfaces in a jet manner. The compressed gas mainly plays the roles of cooling, chip removal and nanofluid conveying. The MQL liquid mainly plays a role of lubrication. The nanoparticles enhance the heat transfer capacity of the fluid in a cutting region and play a good cooling role. Meanwhile, the nanoparticles achieve excellent anti-wear and friction-reducing characteristics and bearing capacity, thereby improving the lubrication effect of a grinding region, greatly improving the surface quality and burn phenomenon of the workpieces, effectively prolonging the service life of the tool and improving the working environment.

Gao Teng et al. invented a NMQL grinding device with ultrasonic vibration-assisted grinding fluid micro-channel infiltration, which has a Chinese application number of 201711278067.1, solves a problem that the thickness of undeformed abrasive dust has great influence on grinding process in the prior art, and has beneficial effects of fully considering a lubrication state of a single abrasive particle when removing materials in the grinding process from a microscopic view, and effectively realizing the effect of ultrasonic vibration-assisted grinding on improving the cooling and lubrication effect of NMQL. A solution is as follows: the device comprises an ultrasonic vibration mechanism capable of adjusting a spatial position of an ultrasonic vibrator; the mechanism is arranged on a workbench; a NMQL grinding mechanism is arranged above a workpiece fixing table; a grinding force measuring mechanism comprises a force measuring instrument and a grinding force controller connected with the force measuring instrument; and the force measuring instrument is arranged at the bottom of the ultrasonic vibration mechanism.

Liu Guotao et al. invented a supply system for coupling supersonic nozzle vortex tube cooling with NMQL, which has a patent number of 20171005238.7 and is composed of a low-temperature gas generating device, a NMQL supply system, a gas distribution control valve and a low-temperature oil-gas external mixing atomizing nozzle. A supersonic nozzle is adopted in the low-temperature gas generating device to improve an outlet speed of a vortex tube nozzle. Flow channels of the vortex tube nozzle are arranged in different streamline forms to improve the vortex intensity of the gas at the vortex tube nozzle and improve an energy separation degree. Heat transfer enhancement measures are taken for a vortex tube heat pipe to effectively improve the refrigeration efficiency. The NMQL supply system can be driven by a motor to more conveniently and accurately control the flow of supplied nanofluid. The supply system has all the advantages of the MQL technology, also has stronger cooling performance and excellent tribological characteristics, effectively solves grinding burn, improves the surface quality of the workpieces, and realizes green and clean low-carbon production featured with high efficiency, low consumption, environmental friendliness and resource conservation.

Jia Dongzhou et al. invented a grinding medium supply system for coupling low-temperature cooling with nanoparticle jet MQL, which has a patent number of 201310180218.5 and comprises at least one MQL and low-temperature cooling nozzle combination unit. The low-temperature cooling nozzle combination unit is arranged on a side of a grinding wheel cover of a grinding wheel and is matched with the workpiece on the workbench and comprises an MQL atomizing micro-nozzle and a low-temperature cooling nozzle, wherein the MQL atomizing micro-nozzle is connected with a nanofluid pipeline and a compressed air pipeline; and the low-temperature cooling nozzle is connected with a low-temperature cooling liquid pipeline. The nanofluid pipeline, the compressed air pipeline and the low-temperature cooling liquid pipeline of each unit are connected with a nanofluid supply system, a low-temperature medium supply system and a compressed air supply system through control valves; and the nanofluid supply system, the low-temperature medium supply system and the compressed air supply system are connected with a control device. The grinding medium supply system effectively solves the grinding burn, improves the surface quality of the workpieces, and realizes green and clean low-carbon production featured with high efficiency, low consumption, environmental friendliness and resource conservation.

However, the above patents have solved a problem of green cooling lubrication or wear resistance of the tool in the cutting process to a certain degree or have developed novel internal cooling tools, but some defects still exist or other necessary problems still need to be reasonably solved.

Specifically, a problem of severe wear of the rake face caused by friction between chips and the rake face in the turning process exists when the service life of the tool is prolonged from the perspective of cooling to reduce the friction and wear.

### SUMMARY OF PRESENT INVENTION

An objective of embodiments of the present specification is to provide an external cooling texture turning tool component with an additional nozzle, which reduces tool-chip friction and rake face wear in a cutting process, thereby prolonging the service life of the tool.

Embodiments of the present specification provide the external cooling texture turning tool component with the additional nozzle, which is realized by the following technical solution:

The external cooling texture turning tool component comprises:

an external cooling turning tool handle and an external cooling turning tool blade;

the external cooling turning tool blade is arranged at one end of the external cooling turning tool handle serving as a bearing device; an external cooling turning tool pad is arranged between the external cooling turning tool blade and a structure of the external cooling turning tool handle bearing the blade;

an external cooling turning tool pressing plate part is further arranged on the external cooling turning tool handle; the external cooling turning tool blade is tightly pressed on the external cooling turning tool handle by the external cooling turning tool pressing plate part;

a texture is machined on a rake face of the external cooling turning tool blade; and the nozzle is erected at a certain distance from the turning tool component.

Embodiments of the present specification provide a process system for coupling NMQL with a texture tool, which is realized by the following technical solution:

The process system comprises:

a machine tool working system, an MQL supply system and a texture turning tool component;

the MQL supply system and the texture turning tool component are mounted on the machine tool working system;

the MQL supply system mainly provides pulsed lubrication and cooling liquid for the texture turning tool component;

the texture turning tool component refers to the external cooling texture turning tool component with the additional nozzle; workpieces mounted in the machine tool working system are rotated; the texture turning tool component performs linear motion under the action of the machine tool working system; and the texture turning tool component cuts the workpieces to generate chips, thereby removing materials of the workpieces.

Embodiments of the present specification provide a process method for coupling NMQL and the texture tool, which is realized by the following technical solution:

The process method comprises:

pouring a formulated MQL oil or NMQL oil into the MQL supply system;

mounting the texture turning tool component in the machine tool working system, and then positioning and clamping;

mounting the workpieces above the machine tool working system, and then positioning and clamping;

determining cutting parameters, then inputting machine tool machining parameters into the MQL supply system, establishing a parameter matching database in an early stage, intelligently identifying the cutting parameters, and matching with an optimal liquid supply amount of the MQL supply system to realize intelligent supply of cutting amount and liquid supply amount.

The workpieces are always rotated in the process of machining the workpieces, while the texture turning tool component performs linear motion under the action of the machine tool working system; and the texture turning tool component cuts the workpieces to generate the chips, thereby removing the materials of the workpieces.

Compared with the prior art, the present disclosure has beneficial effects as follows.

The present disclosure is intended to improve lubrication conditions and friction conditions of the rake face during machining, thereby reducing wear problems during machining. The external cooling texture turning tool component with the additional nozzle according to the present disclosure realizes the nozzle with the atomization effect, thereby realizing precise and controllable supply of MQL liquid. The external cooling texture turning tool component with the additional nozzle is convenient to replace at first and is lower in cost.

An external cooling turning tool according to the present disclosure is simple in structure, low in manufacturing cost, good in manufacturing process, and suitable for production enterprises without long-time machining or with a production program of small batch.

According to the present disclosure, the tool wear in the cutting process is reduced and the service life of the tool is prolonged by a cooling lubrication manner of nanofluid MQL and a characteristic of wear resistance and friction reduction of the texture.

The process system for coupling NMQL with the texture tool according to the present disclosure solves the problems of environmental pollution, harm to human health, increase of manufacturing cost and the like caused by the traditional lubrication mode in the form of MQL, and realizes the reduction of environment-friendly cutting force and the transmission of cutting heat. On the other hand, the surface texture can improve the friction performance of the friction pairs mainly because the micro-dimples or indentations of the surface texture can play the role of the oil reservoir and can form the lubricating films on the surfaces of the friction pairs in time, thereby reducing the friction and wear on the surfaces of the friction pairs and prolonging the service life of the turning tool in the process system. Therefore, the present invention realizes green manufacturing of long service life and low energy consumption, and promotes the improvement of relevant major strategies such as the conversion of new and old kinetic energies and the 13th Five-Year Plan by combining the above various functions.

The process method for coupling NMQL with the texture tool according to the present disclosure can realize low-damage and low-energy-consumption green removal of various cutting materials comprising difficult-to-machine materials through the coupling effect of the NMQL and the texture tool. An exponential equation of the cutting force is established to theoretically guide the cutting parameters of the tool. The cutting parameters are intelligently identified and matched with the optimal liquid supply amount of the MQL supply system to realize the intelligent supply of the cutting amount and the liquid supply amount.

Different MQL states are analyzed, and the lubrication conditions are combined with texture types. The optimal lubrication condition in microscopic state is found, i.e., the lubrication condition in which the NMQL is coupled with micro-texture.

### DESCRIPTION OF THE DRAWINGS

The accompanying drawings forming a part of the present disclosure are adopted to provide a further understanding of the present disclosure. Exemplary embodiments of the present disclosure and descriptions thereof are intended to illustrate the present disclosure, rather than improperly limit the present disclosure.

FIG. 1 is a schematic diagram of an overall structure of an external cooling texture turning tool component with an additional nozzle according to an embodiment I of the present disclosure;

FIG. 2 is an exploded diagram of an external cooling texture turning tool component with an additional nozzle according to the embodiment I of the present disclosure;

FIG. 3 is an overall diagram of a NMQL turning tool process system according to an embodiment II of the present disclosure;

FIG. 4 is an isometric view of a machine tool according to the embodiment II of the present disclosure;

FIG. 5 is a NMQL/MQL supply system according to the embodiment II of the present disclosure;

FIG. 6 is a schematic diagram of force of a turning tool according to an embodiment of the present disclosure;

FIG. 7 is a schematic diagram of force coordinate analysis of a turning tool according to an embodiment of the present disclosure;

FIG. 8 is a schematic diagram of different types of texture forms according to an embodiment of the present disclosure;

FIG. 9 is a schematic diagram of a capillary phenomenon in a turning process according to an embodiment of the present disclosure;

FIG. 10 is a partial enlarged view of a capillary phenomenon according to an embodiment of the present disclosure;

FIG. 11 is a microscopic schematic diagram of a dry cutting state according to an embodiment of the present disclosure;

FIG. 12 is a microscopic schematic diagram of a cast or MQL state according to an embodiment of the present disclosure;

FIG. 13 is a microscopic schematic diagram of a nanofluid in an MQL state according to an embodiment of the present disclosure;

FIG. 14 is a sectional view of a triangular cross-sectional texture according to an embodiment of the present disclosure;

FIG. 15 is a sectional view of a quadrilateral cross-sectional texture according to an embodiment of the present disclosure;

FIG. 16 is a sectional view of an elliptical cross-sectional texture according to an embodiment of the present disclosure; and

FIG. 17 is a schematic diagram of intelligent supply of MQL according to an embodiment of the present disclosure.

In the figures, I-machine tool working system, II-workpiece, III-texture turning tool component, IV-MQL supply system;

I-1—headstock, I-2—adjusting knob, I-3—workpiece clamping device, I-4—machine tool guide rail, I-5—turning tool component, I-6—tip, I-7—tip fixing knob, I-8—lead screw motor, I-9—machine tool tailstock base, I-10—machine tool tailstock, I-11—rotary tool holder component, I-12—longitudinal lead screw motor, I-13—machine tool body;

III-4-a—open texture form, III-4-b-hybrid texture form, III-4-c—closed texture form, III-4-d—semi-open texture form;

IV-1—gas inlet, IV-2—pressure gauge, IV-3—MQL oil storage cup, IV-4—MQL supply system cabinet, IV-5—gas-liquid mixing outlet, IV-6—precise MQL pump, IV-7—gas volume adjustment device, IV-8—supply amount adjustment device, IV-9—branch pipeline, IV-10—pulse generator outlet end pipeline, IV-11—pulse generation device, IV-12—nozzle;

V-1—external cooling turning tool blade, V-2—external cooling turning tool blade positioning pin, V-3—external cooling turning tool pressing plate part, V-4—external cooling turning tool handle, V-5—external cooling turning tool pad, V-6—external cooling turning tool pressing plate fastening screw;

VI-1—chip, VI-2—nanoparticle, VI-3—texture turning tool, VI-4—MQL oil, VI-5—micro-chip and VI-6—microscopic capillary channel.

### DETAILED DESCRIPTION OF PREFERRED EMBODIMENTS

It should be noted that the following detailed description is exemplary and is intended to provide further explanation of the present disclosure. Unless otherwise specified, all technical and scientific terms used herein have the same meanings as commonly understood by those ordinary skilled in the art to which the present disclosure belongs.

It should be noted that the terms used herein are intended to describe specific embodiments only, rather than limit exemplary embodiments according to the present disclosure. As used herein, the singular form is also intended to comprise the plural form unless otherwise clearly specified in the context. In addition, it should be understood that when the terms “contain” and/or “comprise” are used in the present specification, they specify the presence of features, steps, operations, devices, components and/or combinations thereof.

### Embodiment I

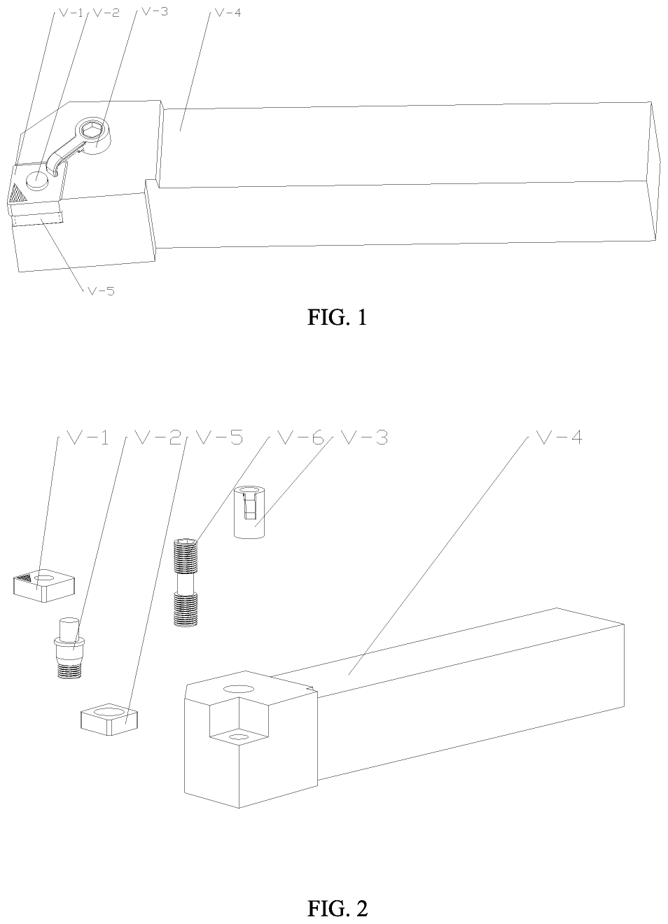

The present embodiment discloses an external cooling texture turning tool component with an additional nozzle. As shown in FIGS. 1 and 2, the external cooling texture turning tool component with the additional nozzle comprises an external cooling turning tool blade V-1, an external cooling turning tool blade positioning pin V-2, an external cooling turning tool pressing plate part V-3, an external cooling turning tool handle V-4, an external cooling turning tool pad V-5 and an external cooling turning tool pressing plate fastening screw V-6.

In the present embodiment, the nozzle is connected externally, i.e., a liquid supply pipeline of an MQL supply system is connected with a nozzle IV-12. Namely, a gas-liquid mixing outlet IV-5 is connected with the nozzle IV-12 through a pipeline, and the nozzle IV-12 is aligned with a friction region of a cutting tool.

MQL oil of the MQL supply system is atomized and sprayed to a tool friction interface of the turning tool component by the nozzle. The turning tool component cuts workpieces fixed to a machine tool working system, thereby realizing material removal machining of materials of workpieces.

The positioning pin has structural characteristics that an upper part of the external cooling turning tool blade positioning pin is a pin column, a lower part comprises threads, and the external cooling turning tool blade positioning pin is used for positioning external cooling turning tool pad and external cooling turning tool pad.

The external cooling turning tool pressing plate part can be specifically seen in FIG. 2, needs inner hole machining threads, and is fixed in place by the threads to press the turning tool blade.

The external cooling turning tool blade V-1 refers to the turning tool blade with certain geometric element requirements. A texture with a certain areal density, width and depth is machined on a rake face. The external cooling turning tool pad V-5 has the same shape as the external cooling turning tool blade V-1 and has thickness size and center hole size different from the external cooling turning tool blade V-1. The external cooling turning tool pad mainly avoids that the external cooling turning tool blade V-1 is deformed because of bearing too large cutting resistance, and uniformly transmits the cutting resistance borne by the external cooling turning tool blade V-1 to the external cooling turning tool handle V-4 by the external cooling turning tool pad V-5.

The external cooling turning tool pressing plate fastening screw V-6 refers to a screw with threads at both ends, and is provided with hexagon sockets at both ends so that the external cooling turning tool pressing plate fastening screw can be controlled to rotate by an internal hexagonal wrench.

The external cooling turning tool pressing plate part V-3 refers to a pressing device of the external cooling turning tool blade V-1, is mounted on the external cooling turning tool handle V-4 by the external cooling turning tool pressing plate fastening screw V-6, and presses the external cooling turning tool blade V-1 to play a role of clamping.

The external cooling turning tool blade positioning pin V-2 is a special pin for positioning the external cooling turning tool blade V-1 and the external cooling turning tool pad V-5. The external cooling turning tool handle V-4 is a bearing device of the external cooling turning tool blade V-1 and the external cooling turning tool pad V-5, and plays a major role of fixedly connecting various components of an external cooling turning tool together and then fixedly connecting to a rotary tool holder component I-11 of a machine tool system by screws.

The texture with a certain areal density, width and depth is machined on the rake face of the external cooling turning tool blade. The texture comprises an open texture, a semi-open texture, a closed texture and a hybrid texture.

The open texture means that the fluid in the texture can flow freely in the texture, i.e., can move in one direction and also flow in a direction with a certain angle to the direction.

The semi-open texture means that the fluid in the texture can only move in one direction under the action of the texture.

The closed texture means that the fluid in the texture does not move in other directions.

The hybrid texture is a combination of the open texture, the semi-open texture and the closed texture in pairs or in threes.

The novel internal cooling turning tool component according to the present embodiment realizes the design of a steerable internal cooling nozzle with atomization effect, and further realizes the precise and controllable supply of MQL liquid.

### Embodiment II

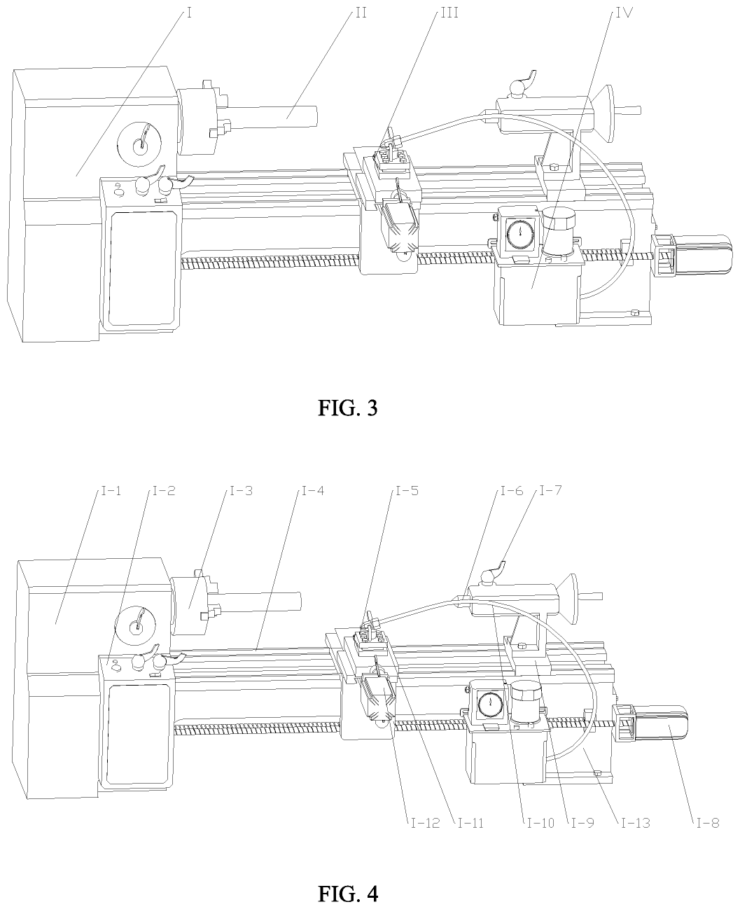

The present embodiment discloses a process system for coupling NMQL with a texture tool provided in the embodiments of the present specification, as shown in FIGS. 3-5, and the process system is realized by the following technical solution:

The process system comprises:

a machine tool working system, an MQL supply system and a texture turning tool component;

the MQL supply system and the texture turning tool component are mounted on the machine tool working system;

the MQL supply system mainly provides pulsed lubrication and cooling liquid for the texture turning tool component;

the texture turning tool component refers to the external cooling texture turning tool component with the additional nozzle; workpieces mounted in the machine tool working system are rotated; the texture turning tool component performs linear motion under the action of the machine tool working system; and the texture turning tool component cuts the workpieces to generate chips, thereby removing materials of the workpieces.

The machine tool working system II can be an engine lathe and can also be a numerically controlled lathe (CNC lathe). The whole process system is described by taking the engine lathe as an example in the present invention. In the case of same components or structures, the process system of the CNC lathe still belongs to the content of the present invention. The workpieces II refer to parts that need to be machined, and are generally rotary parts. The texture turning tool component III mainly refers to a cutting part for turning. The MQL supply system IV mainly provides pulsed lubrication and cooling liquid for the texture turning tool component III.

A workflow of the whole system is as follows: pouring a formulated MQL oil or NMQL oil into the MQL supply system IV before the whole system works; mounting the texture turning tool component III in the machine tool working system I, and then positioning and clamping; and in addition, mounting the workpieces II above the machine tool working system I, and then positioning and clamping.

The workpieces II are always rotated in the process of machining the workpieces II, while the texture turning tool component III performs linear motion under the action of the machine tool working system I. The texture turning tool component III cuts the workpieces II to generate the chips, thereby removing the materials of the workpieces II.

Referring to FIG. 4, a turning machine tool working system I comprises a spindle box I-1, an adjusting knob I-2, a workpiece clamping device I-3, a machine tool guide rail I-4, a turning tool component I-5, a tip I-6, a tip fixing knob I-7, a lead screw motor I-8, a machine tool tailstock base I-9, a machine tool tailstock I-10, a rotary tool holder component I-11 and a longitudinal lead screw motor I-12. A machine tool body I-13 is mainly made of cast iron and machined by a casting technology, and mainly plays the roles of connecting various components together and stably fixing the machine tool working system I on the ground. The spindle box I-1 is a complex transmission component of the turning machine tool working system I, and mainly plays the roles of realizing rotation movement of the workpiece clamping device I-3 and realizing change of different rotating speeds of the workpiece clamping device I-3, start and stop of the workpiece clamping device I-3 and a rotating direction of the workpiece clamping device I-3 and the like. The adjusting knob I-2 can be rotated to adjust a transmission mechanism of the spindle box I-1 to control the change of the start and stop, the rotating speeds and the rotating direction of the workpiece clamping device I-3. A device such as a three-jaw chuck, a four-jaw chuck or a disk chuck can be selected as the workpiece clamping device I-3 according to actual part machining process requirements, and mainly plays the roles of centering and clamping. The rotary tool holder component I-11 mainly plays the role of mounting and fixing the texture turning tool component III. Four tools can be mounted on the rotary tool holder component I-11 at the same time. The principle is that the texture turning tool component III is fixed on the rotary tool holder component I-11 by screws. The longitudinal movement of the rotary tool holder component I-11 is completed by driving a lead screw to move by the longitudinal lead screw motor I-12. The machine tool guide rail I-4 is precisely matched with a worktable of the rotary tool holder component I-11 so as to realize the transverse movement of the rotary tool holder component I-11. The lead screw motor I-8 is a power source for the rotary motion of a lead screw. The machine tool tailstock base I-9 is precisely matched with the machine tool guide rail I-4 to realize the linear movement of the machine tool tailstock I-10 on a guide rail. The tip fixing knob I-7 refers to a fixing knob of the tip I-6. The tip I-6 and the machine tool tailstock base I-9 are relatively stationary by rotating the tip fixing knob I-7. The tip I-6 refers to an auxiliary device for the turning process. When turning a slender shaft, the machine tool tip I-6 can support the slender shaft to reduce the vibration of the slender shaft during machining and improve the machining precision of the workpieces to be machined. The tip I-6 can be replaced with a drilling tool to drill the workpieces or other types of tools for rotary machining of the workpieces. The workpieces II are generally bar stocks, and can also be disks, sleeves or other workpieces with rotary surfaces, such as inner and outer cylindrical surfaces, inner and outer conical surfaces, end surfaces, grooves, threads and rotary forming surfaces.

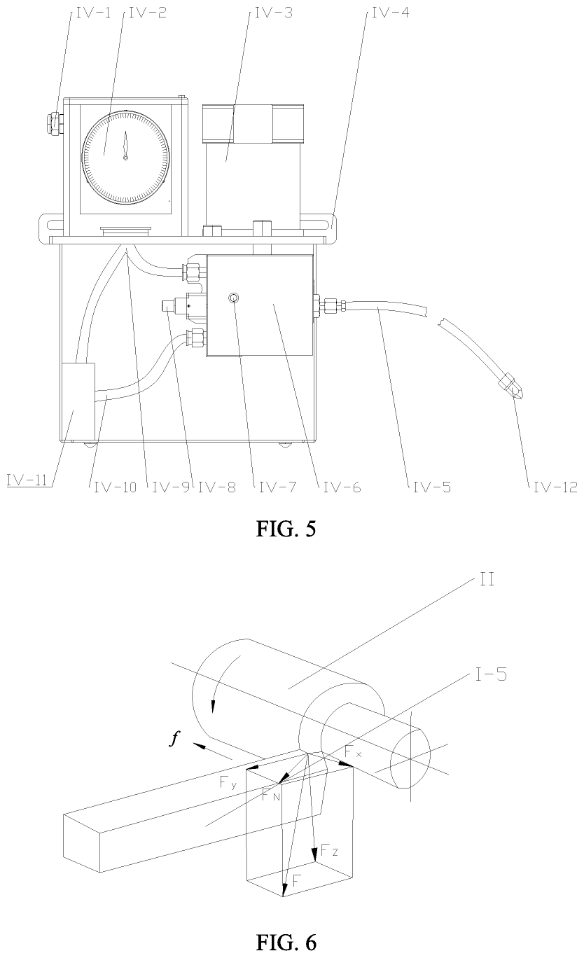

The MQL supply system as shown in FIG. 5 comprises: a gas inlet IV-1, a pressure gauge IV-2, an MQL oil storage cup IV-3, an MQL supply system cabinet IV-4, a gas-liquid mixing outlet IV-5, a precise MQL pump IV-6, a gas volume adjustment device IV-7, a supply amount adjustment device IV-8, a branch pipeline IV-9, a pulse generator outlet end pipeline IV-10 and a pulse generation device IV-11. The gas inlet IV-1 is an interface of an external air compressor. The gas with a certain pressure enters through the gas inlet IV-1. The pressure gauge IV-2 is a device for monitoring the pressure of the gas entering the MQL supply system and can intuitively observe a real-time pressure. The MQL oil storage cup IV-3 is a storage device of the MQL oil. The MQL oil in the MQL oil storage cup IV-3 enters the precise MQL pump IV-6 under the action of gravity. The precise MQL pump IV-6 can produce a quantitative, uniform pulsed MQL oil supply under the action of the pulse generator IV-11. Various parts of the MQL supply system IV can be fixedly connected by the MQL supply system cabinet IV-4 in various connecting manners. The gas-liquid mixing outlet IV-5 refers to an outlet of the MQL oil and the gas, wherein an MQL oil pipeline is a thin pipe; a gas pipeline is a thick pipe; and the thin pipe is nested by the thick pipe. A front end of the pulse generation device IV-11 is connected with a high-pressure gas pipeline; and a rear end is connected with the precise MQL pump IV-6, so that a high-pressure gas transferred from an air compressor is transmitted to the gas-liquid mixing outlet in a pulsing manner. The supply amount adjustment device IV-8 is a knob, and has a working principle similar to that of a faucet; and the dosage of the MQL oil can be controlled by rotating the knob. The gas volume adjustment device IV-7 is a knob; and the knob can be adjusted to adjust a flow rate of the compressed gas entering the precise MQL pump.

A basic principle of the MQL supply system is to pneumatically convey the MQL oil to the nozzle in a pulsing manner (i.e., at intervals), then atomize at the nozzle or the internal cooling turning tool and spray to a designated position. The MQL supply system can be added to the system as a form of outsourcing, and is added to the summary of the present invention in a form of intelligent supply herein.

As shown in FIG. 17, when the intelligent MQL supply is realized, the supply amount of the MQL supply system corresponding to the cutting parameters with long-term practical experience can be inputted into a memory of a control unit by a microcomputer module. When machining parameters are changed, the parameters are inputted into a signal input device; data in the corresponding memory are extracted into the supply amount; and then a mechanical device adjustment knob of the MQL supply device is adjusted to adjust the supply amount.

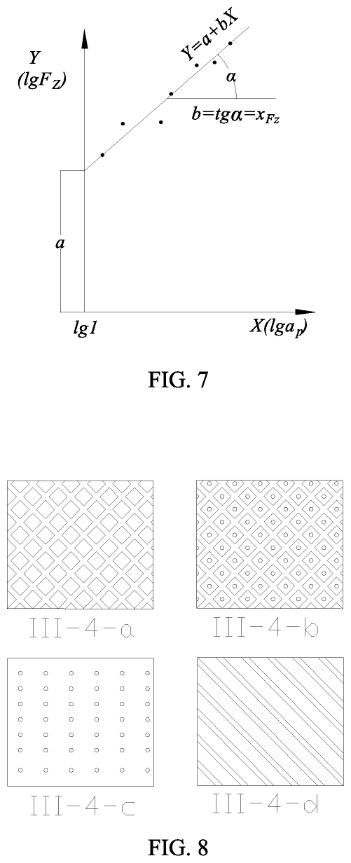

As shown in FIGS. 6 and 7, the forces in the cutting process comprise a cutting force F_{Z}, a back force F_{Y} and a feed force F_{X}.

An exponential equation of the cutting force is obtained through a large number of experiments. The cutting force is measured by a dynamometer, and then the obtained data are processed with a mathematical method to obtain an empirical equation for calculating the cutting force.

F_{Z}=C_{Fz}aₚ^{X}^{_{Fz}}f^{Y}^{_{Fz}}vⁿ^{_{Fz}}K_{Fz}

F_{Y}=C_{Fy}aₚ^{X}^{_{Fy}}f^{Y}^{_{Fy}}vⁿ^{_{Fy}}K_{Fy}

F_{X}=C_{Fx}aₚ^{X}^{_{Fx}}f^{Y}^{_{Fx}}vⁿ^{_{Fx}}K_{Fx}

F_{Z} refers to the cutting force;

F_{Y} refers to the back force;

F_{X} refers to the feed force;

C_{Fz}, C_{Fy} and C_{Fx} depend on coefficients of metal to be processed and cutting conditions;

X_{Fz}, Y_{Fz}, n_{Fz}, X_{Fy}, Y_{Fy}, n_{Fy}, X_{Fx}, Y_{Fx}, and n_{Fx} respectively refer to indices of a back cutting depth aₚ, a feed rate f and a cutting speed v in three component force equations;

K_{Fz}, K_{Fy} and K_{Fx} respectively refer to products of correction coefficients of various factors on the cutting force when actual machining conditions do not match with the conditions for obtaining the empirical equation in calculation of three component forces.

Establishment of an Exponential Equation:

the cutting force is affected by many factors; however, after materials to be processed are determined, the main factors that affect the cutting force comprise the back cutting depth aₚ and the feed rate f; in general, the main factors are included in the empirical equation; and other factors are used as the correction coefficient of the empirical equation.

When experiments on the cutting force are performed, all the factors that influence the cutting force are kept unchanged, and only the back cutting depth aₚ is changed to perform the experiments. When the dynamometer measures different back cutting depths aₚ, the data of several cutting component forces are obtained, and then the obtained data are drawn on double logarithmic paper to form approximately a straight line. A mathematical equation of the cutting force is as follows:

Y=a+bX

In the equation:

Y=lgF_{Z} refers to the logarithm of the main cutting force F_{Z};

X=lgaₚ refers to the logarithm of the back cutting depth aₚ;

a=lgCₐₚ refers to a longitudinal intercept on a straight line F_{Z}-aₚ in logarithmic coordinates; and

b=tga=x_{Fz} refers to a slope of the straight line F_{Z}-aₚ in log-log coordinates.

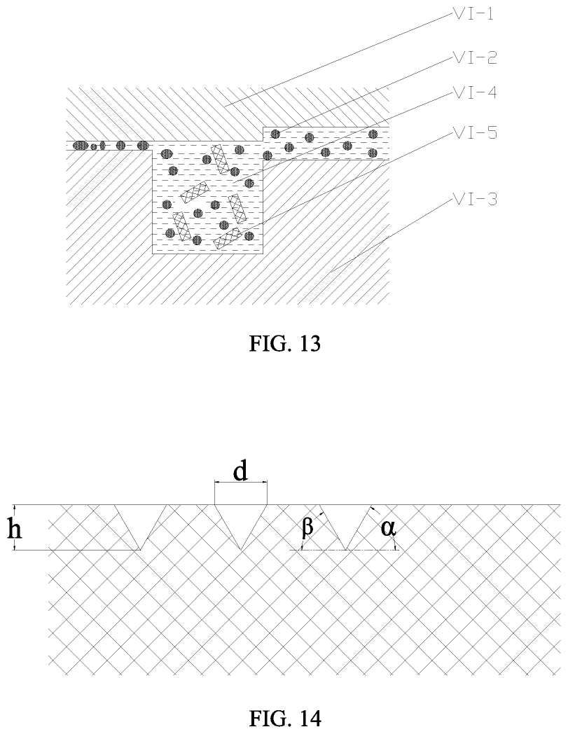

Both a and α can be directly measured from the FIG. 13.

Therefore, the above equation can be rewritten as:

lgF_{Z}=lgCₐₚ+x_{Fz}lgaₚ.

The following equation can be obtained after finishing:

F_{Z}=Cₐₚaₚ^{x}^{_{Fz}}.

Similarly, a relational expression of the cutting force F_{Z} and the feed rate f can be obtained as follows:

F_{Z}=C_{f}f^{y}^{_{Fz}}.

In the equation:

C_{f} refers to the longitudinal intercept of a straight line F_{Z}-f in log-log coordinates; and

y_{Fz} refers to a slope of the straight line F_{Z}-f.

The empirical equation for calculating the cutting force can be obtained by combining the above two equations and influence of each of other minor factors on F_{Z} as follows:

F_{Z}=C_{Fz}aₚ^{x}^{_{Fz}}f^{y}^{_{Fz}}K_{Fz}.

C_{FZ} depends on the coefficients of the materials to be machined and the cutting conditions and can be obtained by substituting actual experimental data into the equation.

K_{Fz} refers to the product of correction coefficients of various influencing factors on the cutting force when actual machining conditions do not match with the conditions for obtaining the empirical equation.

Similarly, the empirical equation of the feed force F_{X} and the back force F_{Y} can be obtained.

The above process can be adopted to predict the cutting force after the turning tool design is completed, thereby providing technical guidance for the selection of reasonable cutting parameters.

After the cutting parameters such as the back cutting depth aₚ, the feed rate f and the cutting speed v are determined, lathe machining parameters are inputted to the MQL supply system; and the cutting parameters are intelligently identified by establishing a parameter matching database in an early stage, and are matched with the optimal liquid supply amount of the MQL supply system to realize intelligent supply of the cutting amount and the liquid supply amount.

Alternatively, when the working system is a CNC turning system, the MQL supply system is connected with the CNC system; programming codes of the CNC system are read; then, the parameters such as the back cutting depth aₚ, the feed rate f and the cutting speed v in the identified codes are extracted according to rules of the programming codes and are fed back to the NMQL supply system; and the cutting parameters are intelligently identified by establishing the parameter matching database in the early stage, and are matched with the optimal liquid supply amount of the MQL supply system to realize the intelligent supply of the cutting amount and the liquid supply amount.

As shown in FIG. 8, the texture forms are classified into an open texture form III-4-a, a hybrid texture form III-4-b, a closed texture form III-4-c and a semi-open texture form III-4-d in the present invention. Tribological characteristics of the textures are related to the areal density (a ratio of the texture area to the total area in the region), depth and width. The textures in various forms can be analyzed by simulation software, and enter a friction and wear testing machine for friction and wear experiments to find the optimal areal density, depth and width of the textures. A secondary lubrication function described below refers to a function of supplying the lubrication liquid to a cutting region (tool/chip friction region) under the external action after the lubrication liquid is stored in the texture region. A chip accommodating function means that tiny chips will be brought into a texture groove in the cutting process and play a role of storage, so as to reduce the friction and wear of other tools. The open texture III-4-a means that the fluid in the texture can flow freely in the texture, i.e., can move in one direction and also flow in a direction with a certain angle to the direction. The semi-open texture III-4-d means that the fluid in the texture can only move in one direction under the action of the texture. The closed texture III-4-c means that the fluid in the texture does not move in other directions. The hybrid texture III-4-b is a combination of the open texture, the semi-open texture and the closed texture in pairs or in threes. The texture forms contain, but are not limited to the illustration.

Compared with the semi-open texture III-4-d, the hybrid texture III-4-b and the closed texture III-4-c, the open texture III-4-a has more excellent lubrication liquid flow characteristics, and is easier to realize “secondary lubrication” during machining: i.e., microstructures with liquid conveying channels supply the MQL oil in texture depressions to the chip/tool friction regions, thereby reducing wear. However, the closed texture form III-4-c has better manufacturability than the open texture form III-4-a, i.e., the closed texture form III-4-c is simple to manufacture, but is easy to cause that the textures are blocked by the solid nanoparticles and the tiny chips after long-term use; thus a liquid lubricant in the NMQL liquid cannot play the functions, but the closed texture form III-4-c is easier to manufacture in actual production. The semi-open texture form III-4-d has advantages and disadvantages of both the closed texture form III-4-c and the open texture form III-4-a, not only has a semi-flow channel for the MQL oil, but also is convenient for machining. Since the function of oil storage or “secondary lubrication” of the textures perpendicular to the chip direction can be played to the largest extent, the anti-wear and friction-reducing performance of the semi-open texture perpendicular to the chip direction is more excellent than that of the semi-open texture form III-4-d in other directions. However, the liquid fluidity of the semi-open texture form III-4-d is inferior to that of the open texture form III-4-a. The hybrid texture form III-4-b is complicated in machining, and is easy to cause that a closed part in the hybrid texture form III-4-b is easily blocked during long-term use. Producers can select appropriate texture machining forms according to actual needs.

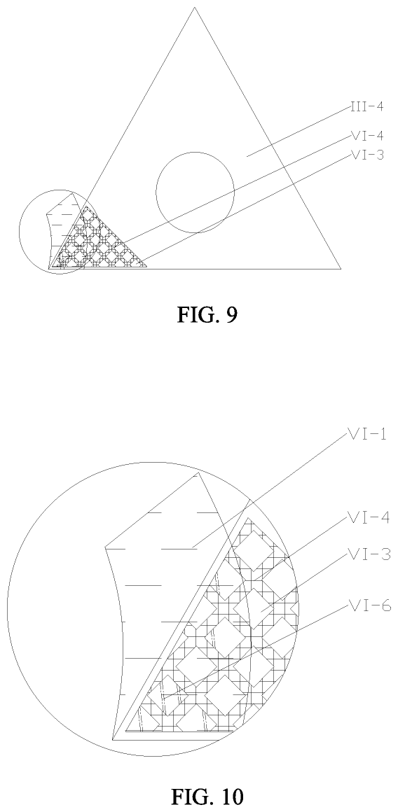

As shown in FIGS. 9 and 10, in the actual machining process, slender microscopic capillary channels VI-6 will be generated between the texture turning tool VI-3 and the chips VI-1 due to the sliding friction of hard points on the chips VI-1. When the microscopic capillary channels VI-6 are communicated with the outside, microscale capillary flow enables the cutting fluid to penetrate into the friction region, thereby effectively improving the lubrication effect of the MQL oil. The capillary flow is a kind of spontaneous movement without driving of external force.

Since the MQL oil supplied by the MQL supply system IV is supplied in the form of small droplets after pneumatic atomization, the droplets are relatively high in speed and easier to enter the microscopic capillary channels VI-6. In addition, since the texture turning tool VI-3 is adopted in the process system, the microscopic capillary channels VI-6 are easier to communicate with the outside. Therefore, the microscopic capillary channels VI-6 and the cutting fluid storage channels of the micro-textures all exist in the whole cutting process under the coupling of dual functions, so that the MQL oil plays a maximum role of lubrication in the device, reduces the friction coefficients and the cutting force, obviously reduces energy required for removing unit materials and improving an energy utilization rate.

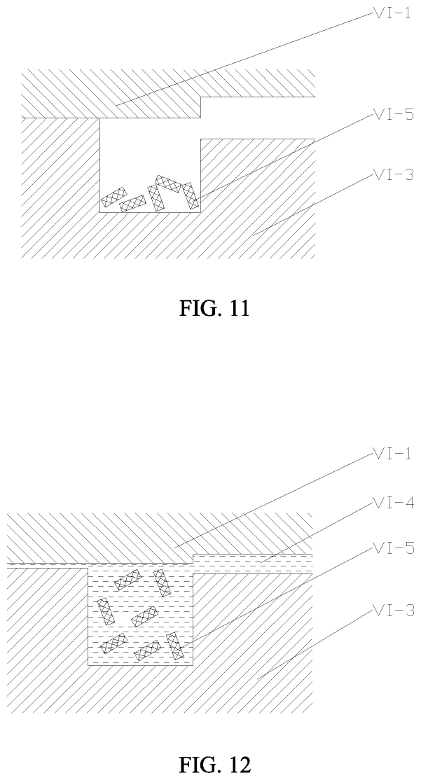

As shown in FIGS. 11, 12 and 13, the friction interface of the texture turning tool VI-3/chips VI-1 in NMQL conditions is analyzed to obtain a coupling effect of the NMQL and the micro-texture tool as follows:

1. The atomized MQL oil VI-4 is also spread in the chip/turning tool friction region to form a regional lubricant oil film or a stable planar oil film, which can also reduce the friction coefficient of the friction region and reduce the wear and cutting force between the friction regions of the texture turning tool VI-3/chip VI-1, thereby prolonging the service life of the whole system. In the NMQL conditions, the nanoparticles VI-2 exist so that the physical lubricant oil film is more easily generated on the friction interface between the texture turning tool VI-3 and the chips VI-1 by the MQL oil, thereby reducing the friction coefficient of a friction contact region and improving the surface machining quality. Meanwhile, the bearing-like effect of the nanoparticles improves the overall lubrication performance.

2. The textures have shown excellent wear resistance without adding any lubricant. However, in the NMQL conditions, the texture groove of the texture turning tool VI-3 exists so that the texture groove can store the MQL oil VI-4 and can supply the MQL oil VI-4 to the friction region in time when the lubrication conditions of the friction region are poor, i.e., the secondary lubrication effect, to realize a gain effect on lubrication in one aspect, and can store the tiny chips VI-5 generated in the friction contact region to reduce the friction and wear caused by the tiny chips VI-5 in the other aspect.

3. The strong heat transfer capacity of nanoparticles can take away the heat from the cutting region in time, thereby avoiding burn damage to the workpieces.

Under the combined action of the above two aspects, the process system can well ensure the surface integrity of the workpieces to be machined, and prolong the service life of the process system, thereby realizing green manufacturing.

The MQL form is different from the NMQL form. Due to the lack of nanoparticles, on one hand, the MQL form has lower heat transfer capacity than the NMQL form; such a lubrication condition is not suitable for machining materials with relatively low thermal conductivity or materials with high continuous machining temperature; and the textures can provide the effects of secondary lubrication and chip accommodation in such a lubrication form, but burn is easily caused during machining due to the insufficiency of heat transfer capacity.

Pouring type lubrication conditions are similar to the MQL, but the pouring type lubrication has the heat transfer capacity slightly better than the MQL since a large amount of liquid can be supplied continuously. The textures can provide the effects of secondary lubrication and chip accommodation. The pouring type lubrication enables a large amount of cutting fluid to enter the cutting region in a liquid jet manner, but easily causes oil rash, folliculitis and other harms, and may produce carcinogenic substances, thereby violating a concept of green machining.

In dry cutting conditions, i.e., cutting conditions without any additional lubrication conditions, the texture can only provide the effect of chip accommodation, but cannot provide the effect of secondary lubrication. Meanwhile, the heat transfer capacity is also a major use obstacle.

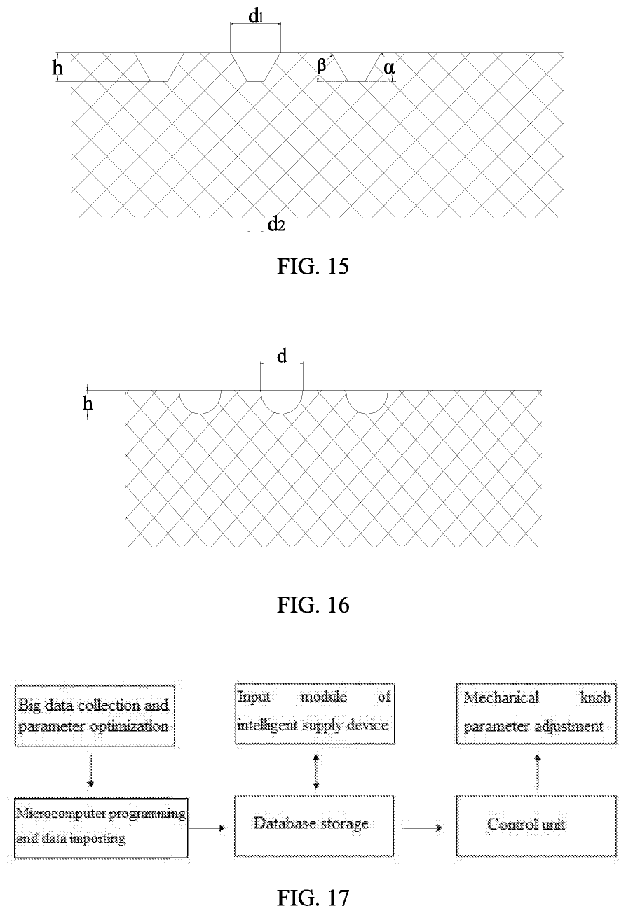

As shown in FIGS. 14, 15 and 16, a cross section of each type of texture can be any manufacturable two-dimensional shape, such as a triangle, a quadrangle, a polygon, a semicircle and a semi-ellipse. Various shape parameters and application situations are analyzed as follows.

For a triangular cross section, the shape has lower oil and chip accommodation regions than other shapes, i.e., the triangle is not conducive to secondary lubrication and chip accommodation at the same depth; the shape parameters mainly comprise a left inclination angle β, a right inclination angle α, a texture width d and a depth h; the left is a triangular edge approximate to a tool tip; and the larger the right inclination angle α is, the stronger the chip accommodating capacity of the texture groove is.

The area of the texture is set as S and the areal density of the texture is set as ϕ; then the oil storage and chip accommodation volume V_{Δ} under this cross section is:

V_{Δ}=½d·h·S·ϕ.

For a quadrilateral cross section, compared with other shapes, the quadrilateral section may have larger oil and chip accommodation regions than other shapes, i.e., the quadrilateral section is conducive to the storage of the lubricant oil and the tiny chips at the same depth; and the shape parameters mainly comprise the left inclination angle β, the right inclination angle α, an upper texture width d₁, a lower texture width d₂ and the depth h.

The area of the texture is set S and the areal density of the texture is set as ϕ; then the oil storage and chip accommodation volume V_{□} under this cross section is:

V_{□}=½·(d₁+d₂)·h·S·ϕ.

For an elliptical cross section, the elliptical cross section has moderate areas of the oil and chip accommodation regions at the same depth, but is easier to manufacture than the quadrilateral cross section when the lubrication liquid in the grooves is impacted, and has performance which is intermediate between the performance of the quadrilateral cross section and the performance of the triangular cross section; and the shape parameters comprise d and h.

The area of the texture is set as S and the areal density of the texture is set as ϕ; then the oil storage and chip accommodation volume V_{O} under this cross section is:

$${V}_{•} = \frac{1}{2} \cdot π \cdot \frac{d}{2} \cdot h \cdot S \cdot φ .$$

It is understandable that the description for reference terms “one embodiment”, “another embodiment”, “other embodiments” or “the first embodiment to the Nth embodiment” in the description of the present specification means that specific features, structures, materials or characteristics described in combination with the embodiment or example are included in at least one embodiment or example of the present invention. The schematic representation of the above terms does not necessarily refer to the same embodiment or example in the present specification. Moreover, the described specific features, structures, materials or characteristics can be combined in an appropriate manner in any one or more embodiments or examples.

The above only describes preferred embodiments of the present disclosure and is not intended to limit the present disclosure. Various modifications and changes can be made to the present disclosure for those skilled in the art. Any modification, equivalent substitution, improvement and the like made within the spirit and principles of the present disclosure shall be included within the protection scope of the present disclosure.

1. An external cooling texture turning tool component, comprising:
an external cooling turning tool handle and an external cooling turning tool blade, wherein
the external cooling turning tool blade is arranged at one end of the external cooling turning tool handle serving as a bearing device; an external cooling turning tool pad is arranged between the external cooling turning tool blade and a structure of the external cooling turning tool handle bearing the blade;
an external cooling turning tool pressing plate part is further arranged on the external cooling turning tool handle; the external cooling turning tool blade is tightly pressed on the external cooling turning tool handle by the external cooling turning tool pressing plate part;
a texture is machined on a rake face of the external cooling turning tool blade; and the nozzle is erected at a certain distance from the turning tool component.

2. The external cooling texture turning tool component according to claim 1, wherein the external cooling turning tool pad has the same shape as the external cooling turning tool blade and has thickness size and center hole size different from the external cooling turning tool blade.

3. The external cooling texture turning tool component according to claim 1, wherein the external cooling turning tool blade and the external cooling turning tool pad are positioned through an external cooling turning tool blade positioning pin.

4. The external cooling texture turning tool component according to claim 1, wherein the external cooling turning tool pressing plate part and the external cooling turning tool handle are fixedly connected through an external cooling turning tool pressing plate fastening screw; and the external cooling turning tool pressing plate fastening screw is a screw with threads at both ends.

5. The external cooling texture turning tool component according to claim 1, wherein the texture is an open texture, a semi-open texture, a closed texture or a hybrid texture.

6. A turning process system for coupling nanofluid minimum quantity lubricant (MQL) with a micro-texture tool, comprising:
a machine tool working system, an MQL supply system and a texture turning tool component, wherein
the MQL supply system and the texture turning tool component are mounted on the machine tool working system;
the MQL supply system mainly provides pulsed lubrication and cooling liquid for the texture turning tool component;
the texture turning tool component is the external cooling texture turning tool component of any one of claim 1; workpieces mounted in the machine tool working system are rotated; the texture turning tool component performs linear motion under the action of the machine tool working system; and the texture turning tool component cuts the workpieces to generate chips, thereby removing materials of the workpieces.

7. The turning process system for coupling NMQL with a micro-texture tool according to claim 6, wherein the nozzle is connected with the end of a supply pipeline of the MQL supply system; and a minimum quantity of lubricating oil is atomized and a minimum quantity of micro-droplets of the atomized lubricating oil is sprayed to a friction interface between the turning tool and the chips.

8. The turning process system for coupling NMQL with a micro-texture tool according to claim 6, wherein the machine tool working system comprises a machine tool body; and the machine tool body is respectively provided with a headstock, a workpiece clamping device, a machine tool guide rail and a rotary tool holder component.

9. The turning process system for coupling NMQL with a micro-texture tool according to claim 6, wherein the machine tool body is also provided with a tip and a machine tool tailstock base; and the tip and the machine tool tailstock base are relatively stationary by rotating a tip fixing knob to adapt to workpieces of different sizes.

10. A control method of the turning process system for coupling NMQL and the micro-texture tool of any one of claim 6, comprising:
pouring a formulated MQL oil or NMQL oil into the MQL supply system;
mounting the texture turning tool component in the machine tool working system, and then positioning and clamping;
mounting the workpieces above the machine tool working system, and then positioning and clamping;
determining cutting parameters, then inputting machine tool machining parameters into the MQL supply system, establishing a parameter matching database in an early stage, intelligently identifying the cutting parameters, and matching with an optimal liquid supply amount of the MQL supply system to realize intelligent supply of cutting amount and liquid supply amount, wherein
the workpieces are always rotated in the process of machining the workpieces, while the texture turning tool component performs linear motion under the action of the machine tool working system; and the texture turning tool component cuts the workpieces to generate the chips, thereby removing the materials of the workpieces.
